(19) United States
(12) Patent Application Publication
(10) Pub. No.: US 2022/0404273 A1
(43) Pub. Date: Dec. 22, 2022

(54) High-Altitude Airborne Remote Sensing

(71) Applicant: Mesos LLC, Houston, TX (US)

(72) Inventors: Robert Kendall, Houston, TX (US); Roelof Jonkman, Mill Valley, CA (US); Samuel Talaber, Houston, TX (US)

(21) Appl. No.: 17/808,094

(22) Filed: Jun. 21, 2022

Related U.S. Application Data
(60) Provisional application No. 63/202,696, filed on Jun. 21, 2021.

(51) Int. Cl. G01N 21/3504; B64C 39/02; G01M 3/38

(52) U.S. Cl. CPC G01N 21/3504; B64C 39/024; G01M 3/38; B64C 2201/127

(57) ABSTRACT

A UAV-carried surveillance and remote sensing platform is launched from a high altitude and flies over a target area, collecting remote sensing imagery before returning to earth. The UAV may be towed to a desired altitude by a powered aircraft or a balloon and then launched for cruising over a target area while capturing data. Instead of being piloted remotely, the UAV employs an autonomous flight control system.

### CROSS-REFERENCE TO RELATED APPLICATION

This patent application claims priority to U.S. Provisional Patent Application No. 63/202,696 filed on Jun. 21, 2021, entitled “High-Altitude Airborne Remote Sensing.” The disclosure of the prior application is considered part of and is incorporated by reference into this patent application.

### TECHNICAL FIELD

The present invention relates to the field of remote sensing, and in particular to a system and technique for high-altitude remote sensing using an airborne vehicle.

### BACKGROUND ART

A need to monitor critical infrastructure or other areas of high importance has driven the development of innovative solutions for remote sensing. Significant efforts have been put into attempts to find cost-effective surveillance technologies that could help organizations find and manage problems in a faster, more efficient way. To date, however, surveillance technology has remained slower and more expensive than would be desirable, limiting the ability to inspect and effectively manage critical zones.

### SUMMARY OF INVENTION

In one general aspect, a high-altitude remote sensing system comprises an autonomous unmanned aerial vehicle; a remote sensing electronics package disposed with the autonomous unmanned aerial vehicle; a balloon, removably tethered to the autonomous unmanned aerial vehicle and capable of lifting the autonomous unmanned aerial vehicle to an altitude of 60,000 to 100,000 feet; and an release system configured to release the autonomous unmanned aerial vehicle at a predetermined altitude.

In a second general aspect, a method of remote sensing comprises provisioning an autonomous unmanned aerial vehicle with a remote sensing electronics package; tethering the autonomous unmanned aerial vehicle to a lifting agent; lifting the autonomous unmanned aerial vehicle to a desired altitude by the lifting agent, wherein the desired altitude is between 60,000 and 100,000 feet; disconnecting the autonomous unmanned aerial vehicle from the lifting agent; flying the autonomous unmanned aerial vehicle autonomously over a target area; and capturing remote sensing imagery in flight by a remote sensing electronics package disposed with the autonomous unmanned aerial vehicle.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIGS. 1A and 1B are photographs illustrating the base platform of a remote sensing aircraft according to one embodiment.

FIG. 2 is a cutaway block drawing illustrating components contained in a remote sensing aircraft according to one embodiment.

FIG. 3 is a block drawing illustrating an array of remote sensing devices according to one embodiment.

FIG. 4 is a block diagram illustrating electronic components for a remote sensing platform according to one embodiment.

FIG. 5 is a block diagram illustrating a remote sensing imagery post-processing system according to one embodiment.

FIG. 6 is a flowchart illustrating a process for performing remote sensing according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation. The actual specialized control hardware or software code used to implement these systems or methods is not limiting of the implementations. Thus, the operation and behavior of the systems and methods are described herein without reference to specific software code with the understanding that software and hardware can be used to implement the systems and methods based on the description herein

As used herein, satisfying a threshold may, depending on the context, refer to a value being greater than the threshold, greater than or equal to the threshold, less than the threshold, less than or equal to the threshold, equal to the threshold, or the like, depending on the context.

Although particular combinations of features are recited in the claims and disclosed in the specification, these combinations are not intended to limit the disclosure of various implementations. Features may be combined in ways not specifically recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

Various types of remote sensing techniques have been used to date. Various parties have used satellites, piloted drones, trucks, airplanes, and combinations of those systems. Drones require a skilled drone pilot to travel from place to place, launch the drone and pilot it in the air, then recover the drone. The data collected by the drone must then be downloaded and analyzed. Because the types of drones used in such a system have significantly limited flight time endurance limitations, the area that can be examined by a drone in a single flight is necessarily also significantly limited. In addition, the time and cost of hiring a drone pilot and transporting the drone pilot from place to place are significant. For example, currently, the pilot has to drive to the drone landing spot, which takes a significant amount of time.

Truck-mounted sensing systems are simpler, typically requiring only a truck driver with sufficient training to operate the truck-mounted sensing equipment. They may also have visual observers drive or ride in the trucks, but these are not as thorough. However, the range of truck-mounted sensing equipment is low, the truck is typically limited to areas with good roads, and the time required to drive the truck from site to site can be extensive.

Satellite-based remote sensing systems are highly expensive, with significant infrastructure required to manage the satellite while in orbit. Although satellite remote sensing systems have increased their capabilities since the earliest Landsat satellites were launched in the 1970s, the resolution of remote sensing satellites with a high revisit rate is still larger than desired, while remote sensing satellites with a better resolution rate typically have a prohibitively low revisit rate.

Aircraft flying at low altitudes providing aerial surveillance has been in use for decades and can provide high-resolution sensing capability. However, a single aircraft flying at a low altitude can cover a limited area at any time. In addition, the cost of the aircraft and skilled pilots are high.

The desired approach is to get high-resolution sensing of large areas at the lowest possible cost. In one embodiment, a high-altitude remote sensing system uses a high-altitude autonomous unmanned aerial vehicle (UAV) that can take off from the ground without the assistance of another vehicle and ascend to high altitudes, where it can cruise over a predetermined target area while collecting remote sensing data. In other embodiments, the UAV can be taken to a high altitude by a balloon or other vehicle and then launched at the desired altitude to cruise under its own motive power. Preferably, the UAV is an autonomous vehicle that operates without a human pilot directing its operation remotely.

For purposes of this discussion, “high altitude” is considered to be in the range of approximately 60,000 feet to 100,000 feet.

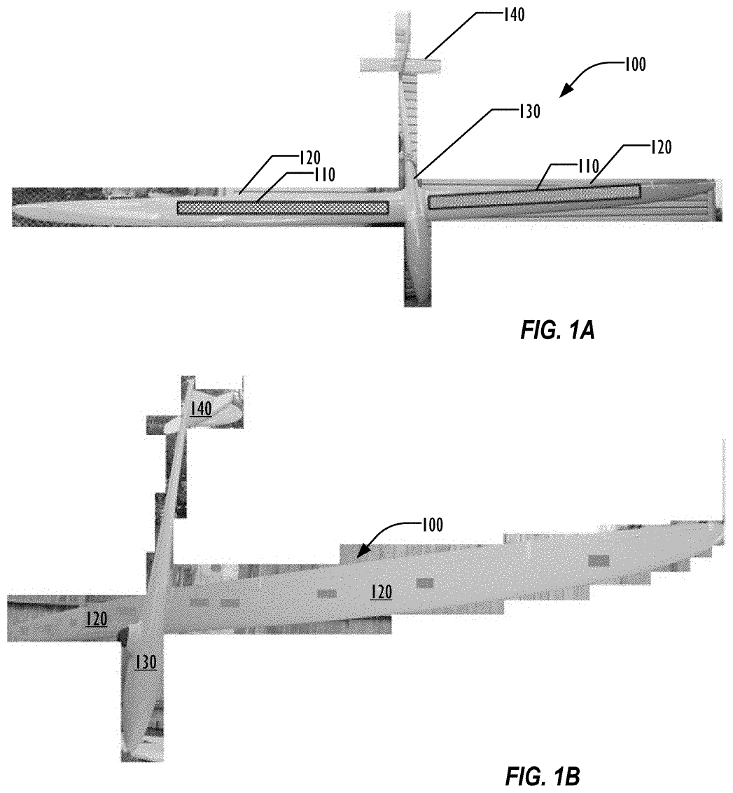

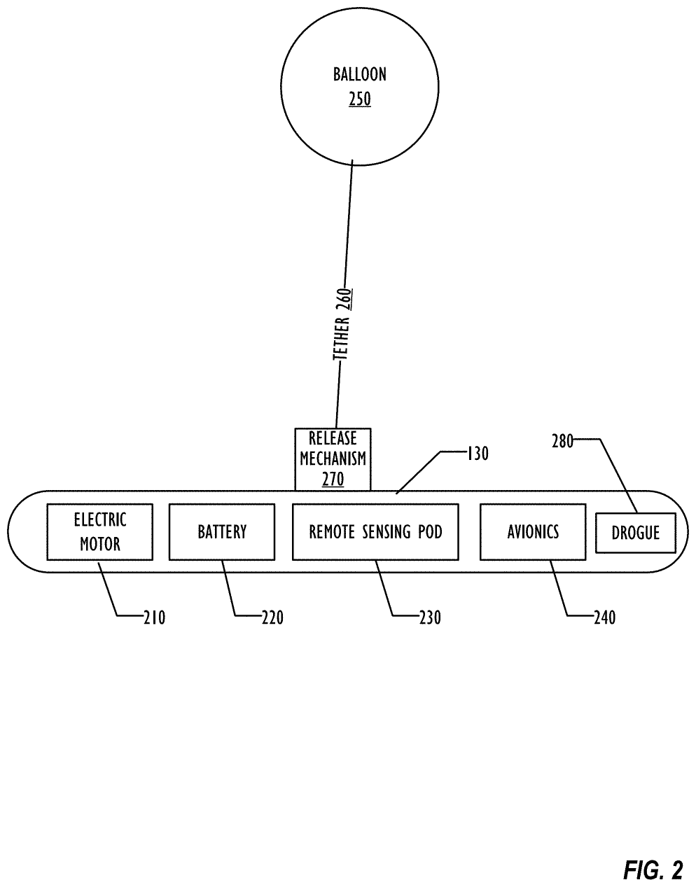

FIGS. 1A and 1B are photographs illustrating a UAV 100 in the form of a sailplane or glider according to one embodiment prior to the addition of an electric motor and propeller coupled to the electric motor in the nose to provide motive power. The UAV 100 acts as the primary structure for the high-altitude remote sensing platform. The UAV 100 may be constructed of various types of high-strength materials, including carbon fiber, fiberglass, foam, and wood. Control surfaces of the UAV 100 contained in the wings 120 or tail 140 for flight control of the UAV 100 may be operated by one or more electric motors 210, drawing from a battery 220, such as a lithium-ion battery, as illustrated in the cutaway view of the fuselage 130 in FIG. 2. In some embodiments, solar panels 110, such as thin-film solar panels, may be deployed on the surface of the UAV 100 to recharge the battery. Although typically placed as illustrated on the wings 120, the solar panels 110 may be placed on other surfaces instead of or in addition to the wings 120. The shape and configuration of the UAV 100 of FIGS. 1A and 1B are illustrative and by way of example only, and the UAV 100 may have any desired configuration and shape

Remote sensing equipment may be mounted interior to the UAV 100 or on the exterior of the UAV 100, such as internal to or on the exterior of the wings 120 or fuselage 130, as desired. The remote sensors may comprise one or more remote sensors of any desired type, including infrared, optical, electro-optical, synthetic aperture radar, multispectral, or hyperspectral cameras. In some embodiments, the remote sensors may be housed in a remote sensing pod 230 or other structure that can be insulated from extreme temperatures and made waterproof. The remote sensing pod 230 may be made of fiberglass or other desired material. One or more onboard data storage devices may also be housed in the remote sensing pod 230 for storing data collected in flight by the remote sensing equipment. Although illustrated as separate components in FIG. 2, one of skill in the art would recognize that any or all of the components 210-220 may be combined with the electronics in the remote sensing pod 230.

The remote sensing equipment sensors are preferably oriented in a nadir position, but can also be oriented in an oblique position.

Avionics and other relevant electronics for controlling the flight of the aircraft may be included in the remote sensing pod 230, a separate pod 240, or mounted directly in the fuselage 130 of the UAV 100. The avionics and other relevant electronics may include an electronic speed controller (ESC) for one or more electric motors 210, servo motors, a detect and avoid system, an Automatic Dependent Surveillance-Broadcast (ADS-B) transmitter, high precision Global Positioning System (GPS), Real-Time Kinematics (RTK), or Global Navigation Satellite System (GNSS) systems and antenna, and any other aircraft control systems. In some embodiments, real-time data transfer to a ground receiver may be enabled by including a transmitter and antenna for radio connections, such as a long-distance local network connection. Airspeed sensors may be used as part of an autopilot control system for controlling the flight of the UAV 100.

In one embodiment, a launching system is provided to take the UAV 100 up to a desired cruising altitude or higher, then engage a release system to automatically release the UAV 100 to cruise under motive power as desired. The UAV 100, upon completion of its remote sensing activity, may then return to the ground and land. Any desired landing gear may be provided to allow the UAV 100 to land safely.

The UAV 100 illustrated in FIG. 1 is illustrative and by way of example only, and other configurations of UAVs may be used as desired, including different shapes for the aircraft structure.

The UAV 100 may be lifted to a predetermined altitude by a lifting agent. In one embodiment in which the lifting agent is a towing aircraft, the UAV 100 may be towed by the towing aircraft to the desired cruising altitude, using any desired mechanism for removably attaching the UAV 100 to the towing aircraft. Such towing equipment is well known in the art and does not need further discussion herein.

In another embodiment, the lifting agent is a balloon launching system, using a helium- or hydrogen-filled balloon 250 that is attached to some portion of the UAV 100 using a tether 260. After reaching the desired cruising or operating altitude in the stratosphere, such as 25 km (approximately 82,000 feet), the UAV 100 may be released from the balloon 250.

In one embodiment, the release mechanism 270 may comprise a hot wire cutdown used to release the UAV 100 from the balloon. In such an embodiment, a large current is passed through a piece of nickel-chromium (“nichrome”) wire. This wire, which is wrapped around a section of synthetic rope, heats up quickly to an orange glow and melts through the rope, literally cutting the UAV 100 down from the balloon.

Hot-wire systems typically use a lithium battery to provide the high current, since lithium batteries are less affected by the extreme cold of high altitudes. The battery used for cutdown is typically isolated from the other flight systems, both to ensure that there is enough power available to heat the wire and also to avoid negative effects of voltage sag or current fluctuations on sensitive computers and radios. The triggering circuit is then a simple relay or transistor switch that is used to make the high-current connection from battery to wire.

A mechanical release system 270 may be used as an alternate to a hot wire system or as a secondary release in case of failure of the hot wire system. The mechanical release system 270 may employ one or more servo motors for activating the release mechanism.

Preferably, the UAV 100 is attached to a small drogue parachute 280 to slow itself down after release and correctly orient itself for a nose-down attitude to build up airspeed over the wings, providing lift. Elevators or other similar aircraft control structures are then adjusted to raise the nose of the UAV 100 to pull itself out of the dive. Once the UAV 100 is level, it may begin traveling to the target area.

In embodiments in which the UAV 100 is an autonomous vehicle, a flight path may be preprogrammed before launch or a flight path may be communicated from a ground control station to the UAV 100 via radio from an automatic tracking antenna. An onboard flight computer and autopilot software may then control a path of the flight of the UAV 100 over the target area. In some embodiments, an optional pilot control system may allow a ground-based pilot to control the UAV 100 as desired, such as in the event of a failure or malfunction of the autopilot. A navigation system, such as a GPS navigation system may confirm the location of the UAV 100 and initialize data collection by the remote sensing equipment once the UAV 100 is over the target area. In some embodiments, an integrated navigation system can consolidate multiple inputs, compare the positions, remove outliers, and output a single position to provide a more resilient basis for navigation of the UAV 100.

Because the UAV 100 is a low-weight aircraft with a high glide ratio, the UAV 100 and remote sensing equipment may stay aloft for long periods, such as over 10 hours, before needing to land. This allows the UAV 100 to loiter over the general target area in the event of cloud coverage over the target area that would prevent obtaining clear remote sensing imagery until the cloud coverage has cleared sufficiently that clear imagery is available.

Once the remote sensing system has completed data capture, the UAV 100 may descend while flying to a predetermined landing zone where the UAV 100 may be recovered and remote sensing data that is stored onboard may be transferred to a ground-based computer for processing as described below. In the event of an uncontrollable descent or any other major malfunction of the UAV 100 that cannot be corrected, embodiments may provide a backup parachute that can be deployed to bring the UAV 100 down at a safe speed. Geospatial data obtained from the navigation system may be attached to the remote sensing imagery.

The data collected from the remote sensing equipment on the UAV 100 may be inspected individually or processed using algorithms to join the raw data captures (multispectral, hyperspectral, optical, etc.) and stitch the imagery into a panoramic view of the target area for monitoring. In addition, the data may be processed to determine changes in the state of the target area or the area surrounding the target area, by referencing previous results to detect changes along a right-of-way, such as vegetation growth or death, hydrocarbon leakage, or any other unwanted disturbance or intrusion.

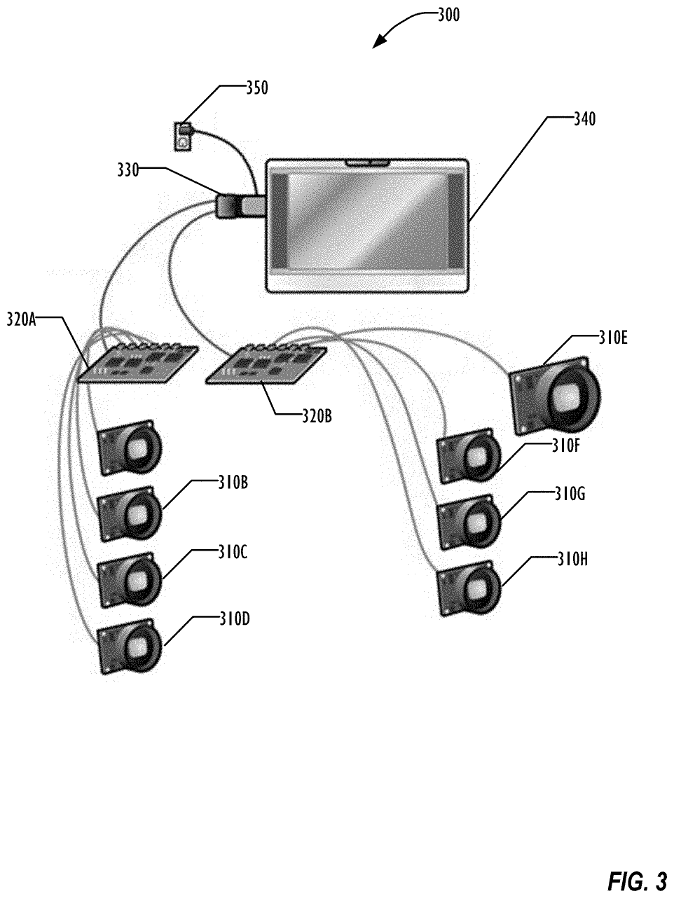

FIG. 3 is a block diagram illustrating a system 300 comprising an array of cameras 310A-H for producting remote sensing imagery according to one embodiment, as well as supporting equipment, some of which may be mounted remotely to the array of cameras. Any desired type of camera may be used, including infrared, optical, multispectral, and hyperspectral cameras. Embodiments may use an array of multiple camera types as desired.

In this example, each of the eight cameras 310A-H are connected via a connector to one of a pair of hubs 320A-B. The hubs 320A-B are then connected to an interface card 330 that provides a connection to a computer 340. Although illustrated as an external card in FIG. 3, the interface card 330 may be an internal component of the computer 340 and may be implemented with an interface on the motherboard of the computer 340. The interface card 330 is connected to a power source 350 to provide power to the cameras 310A-H, hubs 320A-B, and interface card 330. Data from the cameras 310A-H can then be collected by the computer 340 for analysis, storage, etc. The power source 350 may be a battery or any other available source of electrical power. The computer 340 may share the power source 350 with the cameras 310 or have a separate power source (not shown in FIG. 3), which may be independent of the power source 350. For storage of remote sensing imagery, the computer 340 may use a hard drive, a solid-state drive, or any other convenient form of data storage hardware.

The number of cameras 310A-H and hubs 320A-B is illustrative and by way of example only, and any type or number of cameras or hubs may be used as desired, such as to fit into a desired form factor for the camera array. Any convenient type or types of connectors and communication protocols can be used as desired, such as Universal Serial Bus Type C (USB-C). The computer 340 may be any type of device capable of connecting to the cameras 310A-H for collecting the data. In some embodiments, the data is simply collected by the computer 340, then made available for later analysis by other computers or other devices. In other embodiments, the data collected by the computer 340 may be processed or analyzed in real-time during flight, and the analysis used to guide the path of UAV 100 or to provide any other useful guidance to an operator of the sensing system 300. In some embodiments, the data collected by the computer 340 is continuously processed in situ and stored on the computer 340 or another device in the UAV 100 from which the data may be downloaded after the flight. In some embodiments, the data may be transmitted while in flight to a ground station via a wireless network, a satellite data network, or a mobile telephone data network such as a 4G or 5G data network. Although illustrated in FIG. 3 as all of the same type, each of the cameras 310 may be of a different type and configuration. For example, in some embodiments, some of the cameras 310 may be multispectral cameras while others may be hyperspectral cameras. Typically, the captured data includes altitude, heading, and other associated metadata in addition to the remote sensing data captured by the cameras 310.

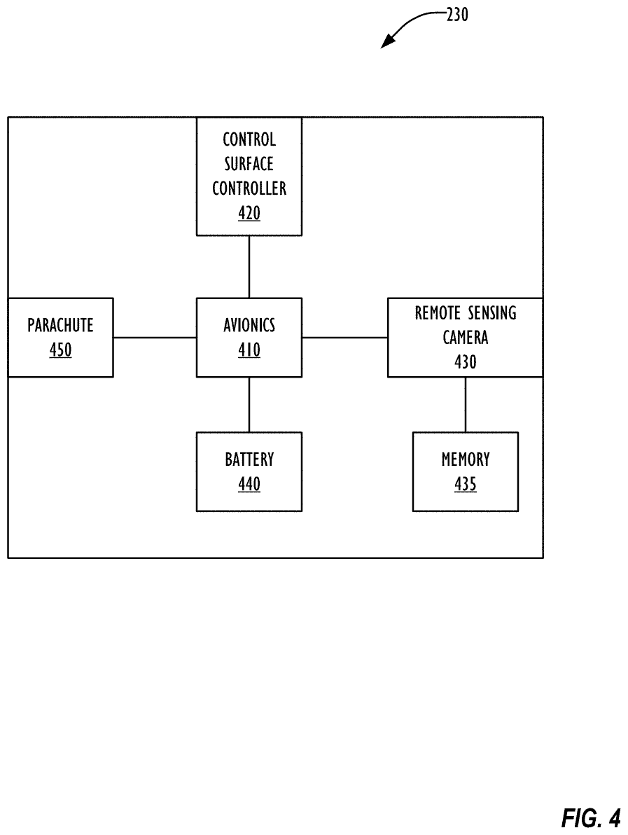

FIG. 4 is a block diagram illustrating an electronics package for a UAV 100 according to one embodiment in which the electronics package is contained in a remote sensing pod 230. An avionics processor 410 and related components can be used for controlling control surfaces of the UAV 100 via control surfaces controls 420. Typically, the control surfaces controls 420 use mechanical connections, electrical motors, or hydraulics to control the control surfaces of the UAV 100. A battery 440 provides power for the electronics package. One or more cameras 430 may be controlled by the avionics processor 410 for performing remote sensing. In some embodiments, the camera 430 is configured to capture images and store them in internal memory or an external storage device 435, such as a solid-state storage device. In embodiments configured with a parachute safety device, parachute controls 450 manage the deployment of the parachute under the control of the avionics processor 410. In some embodiments, transmitters on the UAV 100 may communicate with the camera 430 and transmit the captured images to receivers to a ground station or base station for further dissemination of the images for analysis.

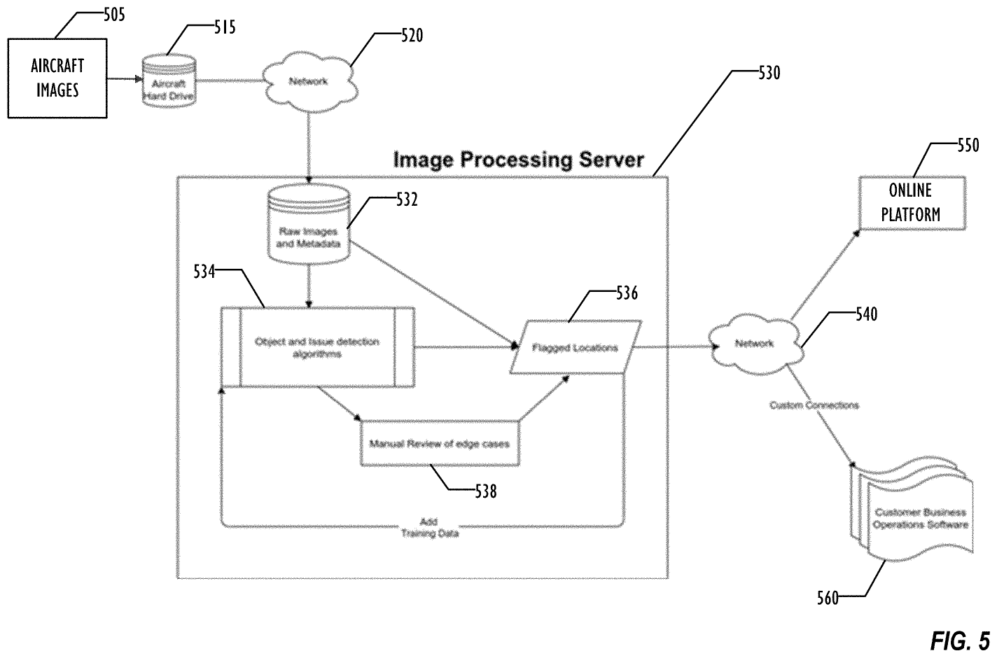

FIG. 5 is a block diagram illustrating a system for post-processing remote sensing imagery according to one embodiment. In one embodiment the remote sensing imagery captured by the remote sensing system described above can be processed by post-processing software to create a system for monitoring pipeline rights-of-way from aerial imagery without human intervention. The onboard computer 340 may preprocess captured remote sensing imagery allowing for rapid processing of pipeline threats on a ground-based server, in which machine learning software may flag locations to send off to a human to intervene. Their feedback may also be used to improve the software automatically.

As described above, an onboard computer 340 may process the captured remote sensing imagery in flight. The computer 340 may be attached to both the onboard flight computer and the cameras 310 to get all required information.

Prior to any information being processed, a targeted pipeline's geographic data may be loaded to the aircraft's onboard computer 340 along with the flight plan. Using this information, the computer 340 may be programmed to begin processing when the pipeline is in the line of sight of the cameras 310. Whilst in flight, a lightweight object identification program on the aircraft may assign to each image 505 a likelihood that there are right-of-way objects in the pipeline. This program may use the pipeline's geographic location along with a lightweight object detection program. This results in a set of images on the hard drive 515 along with associated object likelihoods.

Once on the ground, the hard drive 515's contents will be transferred through one or more networks 520, such as the internet, to a database 532 associated with a ground-based server 530 that may execute image processing software 534 such as a large neural network or other object and issue detection analysis software to identify objects in the captured remote sensing imagery. In one embodiment, Images may be processed in order of likelihood from the airborne computations. This allows the ground-based computer to send likely issues to users as fast as possible. The program may put a running list of flagged locations into a database 536 that users may be able to view in real time. Edge cases may be flagged and manually reviewed by a human in the loop as indicated in block 538.

This list of images with right-of-way objects in the database 536 may be shown to users via one or more networks 540 through an online platform 550 provided by a service provider or customer business operations software 560. In some embodiments, all images may be available, but only issues and their corresponding imagery may be raised to users. The flagged images may be shown with optional feedback buttons to correct the algorithm, such as to create a custom input square of the object or to remove a flagged image. These images may then be sent back to the image processing software 534 as training data.

The software executed by the onboard computer 340 may be constrained to run on a computer of limited processing power and may be a standard rules-based algorithm, instead of a machine learning algorithm. Inputs may include a pipeline geographic data file, a current camera location, and the image itself. This program may then draw a line over the expected location of the pipeline and compute a difference gradient over the length of the pipeline in the image. That gradient may then be normalized by the pixel length of the pipeline in the image producing a likelihood value for use by the ground-based server 530.

In one embodiment, the image processing software 534 may include a convolutional neural network. Inputs may include the expected pipeline location, the camera location, and the output of the aircraft pre-processing. The outputs of this program may be boxes identifying the location of objects along the pipeline with a likelihood of those objects infringing the right-of-way of the pipeline. In one implementation all objects with a threshold confidence level (e.g., a 90+%) may be flagged to show the user. Any objects with medium-level confidence (e.g., 50%-90%) may be sent to a human for manual review. This program may be trained on an existing corpus of pipeline imagery, but may also be retrained periodically (e.g., weekly) on additional data. All manually reviewed data, along with flagged data may be sent to this continually increasing corpus of training imagery.

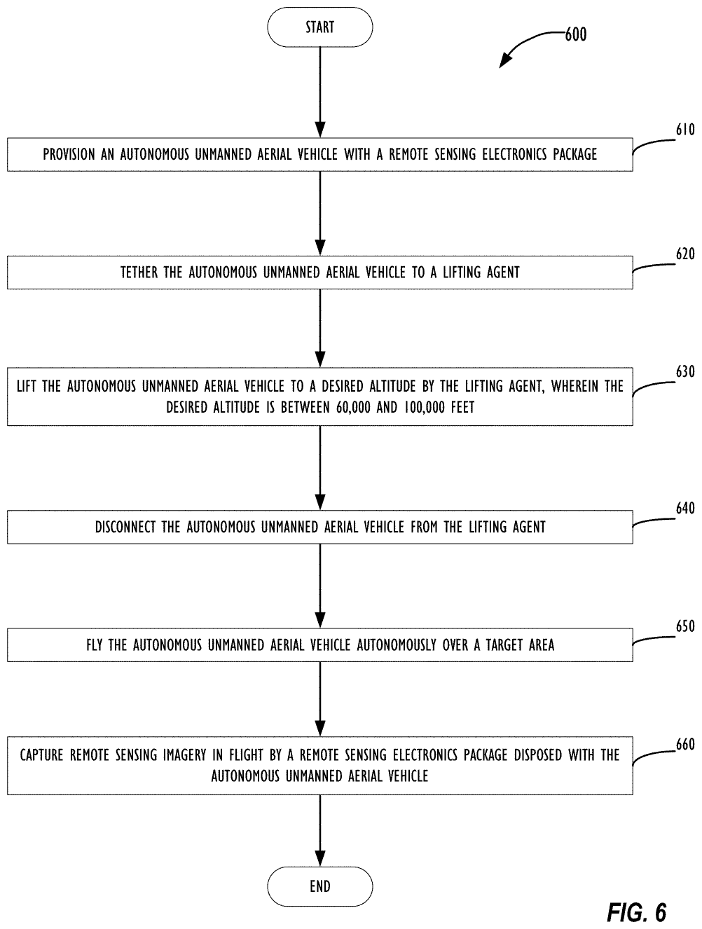

FIG. 6 is a flow chart of a process 600, according to an example of the present disclosure. According to an example, one or more process blocks of FIG. 6 may be performed by a high-altitude remote sensing autonomous unmanned aerial vehicle as described above.

As shown in FIG. 6, process 600 may include provisioning an autonomous unmanned aerial vehicle with a remote sensing electronics package (block 610). As in addition shown in FIG. 6, process 600 may include tethering the autonomous unmanned aerial vehicle to a lifting agent (block 620). As also shown in FIG. 6, process 600 may include lifting the autonomous unmanned aerial vehicle to a desired altitude by the lifting agent, where the desired altitude is between 60,000 and 100,000 feet (block 630). As further shown in FIG. 6, process 600 may include disconnecting the autonomous unmanned aerial vehicle from the lifting agent (block 640). As in addition shown in FIG. 6, process 600 may include flying the autonomous unmanned aerial vehicle autonomously over a target area (block 650). As also shown in FIG. 6, process 600 may include capturing remote sensing imagery inflight by a remote sensing electronics package disposed with the autonomous unmanned aerial vehicle (block 660). As further shown in FIG. 6, process 600 may include 12. The method where (block 670).

It should be noted that while FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

While certain example embodiments have been described in detail and shown in the accompanying drawings, it is to be understood that such embodiments are merely illustrative of and not devised without departing from the basic scope thereof, which is determined by the claims that follow.

We claim:

1. A high-altitude remote sensing system comprising:
an autonomous unmanned aerial vehicle;
a remote sensing electronics package disposed with the autonomous unmanned aerial vehicle;
a balloon, removably tethered to the autonomous unmanned aerial vehicle and capable of lifting the autonomous unmanned aerial vehicle to an altitude of 60,000 to 100,000 feet; and
an release system configured to release the autonomous unmanned aerial vehicle at a predetermined altitude.

2. The high-altitude remote sensing system of claim 1, wherein the release system comprises a hot wire cutdown mechanism.

3. The high-altitude remote sensing system of claim 1, wherein the release system comprises a mechanical release employing one or more servo motors.

4. The high-altitude remote sensing system of claim 1, further comprising a drogue chute disposed with the autonomous unmanned aerial vehicle.

5. The high-altitude remote sensing system of claim 1, wherein the remote sensing electronics package is disposed in a pod disposed external to the autonomous unmanned aerial vehicle.

6. The high-altitude remote sensing system of claim 1, wherein the remote sensing electronics package is disposed within a fuselage of the autonomous unmanned aerial vehicle.

7. The high-altitude remote sensing system of claim 1, further comprising:
a propeller disposed on the autonomous unmanned aerial vehicle providing motive power for the autonomous unmanned aerial vehicle; and
an electric motor coupled to the propeller.

8. The high-altitude remote sensing system of claim 1, wherein the remote sensing electronics package comprises:
a camera; and
an onboard data storage device, connected to the camera for storing data collected in flight by the camera.

9. The high-altitude remote sensing system of claim 1, further comprising:
an autopilot software for flight control of the autonomous unmanned aerial vehicle.

10. The high-altitude remote sensing system of claim 9, further comprising:
a navigation system, programmed to initialize data collection by the remote sensing electronics package once the autonomous unmanned aerial vehicle is over a predetermined target area.

11. A method of remote sensing, comprising:
provisioning an autonomous unmanned aerial vehicle with a remote sensing electronics package;
tethering the autonomous unmanned aerial vehicle to a lifting agent;
lifting the autonomous unmanned aerial vehicle to a desired altitude by the lifting agent, wherein the desired altitude is between 60,000 and 100,000 feet;
disconnecting the autonomous unmanned aerial vehicle from the lifting agent;
flying the autonomous unmanned aerial vehicle autonomously over a target area; and
capturing remote sensing imagery in flight by a remote sensing electronics package disposed with the autonomous unmanned aerial vehicle.

12. The method of claim 11, wherein lifting the autonomous unmanned aerial vehicle to the desired altitude by the lifting agent comprises towing the autonomous unmanned aerial vehicle to the desired altitude.

13. The method of claim 11, wherein lifting the autonomous unmanned aerial vehicle to the desired altitude by the lifting agent comprises lifting the autonomous unmanned aerial vehicle with a balloon to the desired altitude.

14. The method of claim 11, wherein disconnecting the autonomous unmanned aerial vehicle from the lifting agent comprises activating a hot wire cutdown.

15. The method of claim 11, further comprising:
activating a drogue parachute to slow down and orient the autonomous unmanned aerial vehicle for flying to the target area.

16. The method of claim 11, further comprising:
flying the autonomous unmanned aerial vehicle to a predetermined landing zone.

17. The method of claim 11, further comprising:
stitching remote sensing imagery captured by the remote sensing electronics package into a panoramic view of the target area.

18. The method of claim 11, further comprising:
processing remote sensing imagery captured by the remote sensing electronics package; and
determining changes in state of the target area or an area surrounding the target area.

19. The method of claim 11, further comprising:
analyzing remote sensing imagery collected inflight; and
guiding a path of the autonomous unmanned aerial vehicle responsive to the analysis.

20. The method of claim 11, further comprising:
transmitting captured remote sensing imagery from the autonomous unmanned aerial vehicle in flight to a ground station.
